(19) United States
(12) Patent Application Publication
(10) Pub. No.: US 2004/0135454 A1
(43) Pub. Date: Jul. 15, 2004

(54) ROTARY ELECTRICAL DEVICE

(75) Inventor: Hideaki Takahashi, Shuuchi-gun (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Shuuchi-gun (JP)

(21) Appl. No.: 10/707,589

(22) Filed: Dec. 23, 2003

(30) Foreign Application Priority Data
Jan. 10, 2003 (JP) 2003-003887

(51) Int. Cl. H02K 21/12; H02K 1/00

(52) U.S. Cl. 310/156.45; 310/156.06; 310/216

(57) ABSTRACT

A rotary electrical machine device that reduces the distortion generated in the waveform of the electromotive force as much as possible while adopting inexpensive processes and assembling methods.

### BACKGROUND OF INVENTION

This invention relates to a rotary electrical machine that provides a compact and simply constructed structure that reduces the harmonic components in the wave form existing between the permanent magnets and cooperating wound pole teeth on relative rotation.

Normally these machines, which may comprise either motors or generators are comprised of cooperating relatively rotatable components comprised of a plurality of circumferentially spaced permanent magnets that cooperate with the tops of a plurality of pole teeth around which electrical coils are wound. If the machine is a motor, the coils are sequentially energized to effect rotation. If it is a generator it is driven and a voltage is generated in the coil windings. These type of machines may assume many forms.

There conventional magnetic field type rotary electric devices adopt either an inner permanent magnet (IPM) structure in which permanent magnets for forming a magnetic field are buried in a stator yoke (core) or rotor yoke made from magnetic materials or the surface permanent magnet (SPM) structure in which the permanent magnets are disposed on the surface of the core at certain intervals.

One form of IPM structure is shown in Japanese Published Application Hei 09-275645. This Published Patent Document discloses an IPM structure for a motor in which the stator is constructed with a core having plural magnet insertion holes within the inner peripheral surface of the core and into which magnet plates are inserted.

Japanese Published Application 2002-27690 shows another IPM structure. In this construction, to facilitate flux distribution, a semi cylindrical bulge section is disposed on the outer edge of the core on the diameter line connecting the center line of the permanent magnet and the center of the rotor core.

These IPM constructions have disadvantages because a part of the flux emitted from the permanent magnets to form the magnetic fields is shunted and flows through the inside of the core through the resulting gap between the core outer edge and the permanent magnet. It also causes flux leakage because it does not reach the rotor core or stator core, and therefore results in efficiency reduction that produces a drop in torque output if the machine is motor or a reduction of electromotive force if the machine is generator.

With the SPM structures, the permanent magnets for forming a magnetic field are implanted on the surface of the rotor core and directly face the wound poles of the stator. Thus the permanent magnets can be positioned as close as possible to the magnetic pole of the coil. The flux flow of the permanent magnets acts on the windings through the very small gap. This permits the waveform of the electromotive force to approaches an approximately sinusoidal waveform. In this way that torque pulsation can be reduced. Therefore, there is a trend toward a greater use of the SPM type of structures.

One typical SPM structure is shown in Published Japanese Application Hei 09-275648. In this arrangement, the stator containing the permanent magnets is disposed around the rotor having the wound pole teeth. The stator is provided with pairs of spaced magnet plates in V-shape with their edges abutted open toward the wound poles.

Another SPM type of structure is shown in Japanese Published Application 2000-166141A. In this arrangement, the permanent magnets are carried by the rotor and are bonded in grooves formed on the outer peripheral surface of the cylindrical rotor at predetermined intervals. The permanent magnets have a semi cylindrical shape with a curved surface that faces the wound pole teeth of the stator.

Although the SPM type of structures have the aforenoted advantage over the IPM structures, there is still room for improvement. Their shortcoming and particularly those of the last noted example may be best understood by reference to FIGS. 1-5. Referring now initially to FIGS. 1 and 2, a rotary electric device of this type is identified generally at 21 and is comprised of an annular stator 22 that surrounds a rotor 23. The stator 22 is constructed with thin laminated bodies of a magnetic material having a circular core 24 from which a plural pole teeth 25 extend radially inward inwardly. Slots 26 (18 slots in the shown example) are formed between the teeth 25. Coil 27 are wound around each of the teeth 25 into the slots 26 on the sides of the teeth 25.

The rotor 23 is constructed similar to the stator 22 with thin plates of a laminated magnetic material 28 of a generally cylindrical configuration and forming a cylindrical outer peripheral surface 29. A plurality of permanent magnets 31 (12 magnets in the exemplary drawing) are suitably fixed to the surface 29 at regular circumferential intervals. The rotor 23 is rotatably supported on a rotor shaft 32 that is suitably journalled, for example by roller bearings (not shown).

A rotary electric device 21 having such SPM structure can function as a motor in which the rotor 23 is rotated by the effects with the flux on the rotor 23 when the magnetic field is formed by the current input to the coils 27 of the stator 22 is applied in a predetermined sequence for the flux flow of the magnetic fields formed by the permanent magnets 31 of the rotor 23. Alternatively, the rotary electric device 21 having the SPM structure described can be constructed as a generator in which electromotive force can be taken from the coils 27 when the rotor 23 is rotated by an external mechanical torque.

In such construction of a rotary electric device 21 having SPM structure, the waveform of the electromotive force approaches to an approximately sinusoidal waveform as described previously. However, when there are many harmonic components included in the electromotive force of the sinusoidal waveform and thus the distortion factor is high. These harmonic components can induce malfunctions of peripheral devices when the machine 21 functions as a generator. Also when the machine 21 functions as a motor problems are encountered such as torque pulsations caused by the harmonic components in case of a brushless motor.

In order to prevent such problems, attempts are conventionally made such that windings 27 are selectively wound and the opposed surface 31a of the permanent magnet 31 facing the stator 22 is curved to form a semi cylindrical shape as shown in the partially enlarged view of FIG. 2 in an effort to control the flux flow to reduce the harmonic components. However, there are disadvantages to these approaches. For example when the distributive winding method is adopted, the winding end (coil end) protruding at both axial ends of the stator 22 is substantial and accordingly the axial dimension of the stator 22 increases to naturally enlarge the size of the rotary electric device. Therefore, there is a disadvantage that the device cannot satisfy the small sizing requirements when it is applied to various applications such as a power source motor and/or a generator.

Also as shown in FIG. 2, the structure in which the permanent magnet 31 is shaped into the arc concentric with the rotor shaft 32 requires substantial labor for the initial processing of the permanent magnets and thus makes the resulting machine overly expensive. Furthermore, as will now be described, these attempts are not totally effective in improving the electrical performance.

Referring now to FIG. 3, this shows a waveform chart in the rotary electric device 21 shown in FIG. 1 by detecting the waveform of the counter electromotive force generated during rotation in order to analyze the magnetic field analysis waveform in case that each of the permanent magnets 31 of the rotor 23 has an outward arc shape as shown in FIG. 2. This waveform includes the harmonic components in spite of the fact that the arc shape is given to the pole face of the permanent magnets 31. Thus it is found from the fundamental sinusoidal waveform that the distortion nevertheless has occurred.

The result of analysis separation of such magnetic field analysis waveform into each order after Fourier expansion is shown in a graph of FIG. 4, in which the vertical axis shows the component value of the electromotive force for each order and the horizontal axis shows the respective orders. As seen from the graph of FIG. 4 there are many harmonic components of 5th, 7th, 11th, and the like and that the harmonic components of the other orders are also generated.

When the harmonic components of each order (2nd through 20th) are further enlarged, as shown in FIG. 5, harmonic components of electromotive force of almost all orders are generated. These harmonic components are found to be total harmonic distortion (T.H.D)=7.26% as a result of calculating the ratio to the fundamental electromotive force components. Therefore, this prior art attempted solution is not preferable because it may induce the aforementioned malfunctions of the peripheral devices as a result of the harmonic components and may cause the generation of the torque pulsation (torque ripple). T.H.D is a total of distortion in each order. In this example, it is a total of distortion from 1st order through n th order may be expressed as follows:

T.H.D=√{0.06(2nd order)}²+{0.02(3rd order)}²+ . . . {n-th order}²/{6.81(1st order)}² =7.26%

Therefore it is a principal object of this invention to provide an improved, simplified, low cost rotary electrical machine.

It is a further object of the invention to provide a rotary electrical machine in which the permanent magnets are mounted to the rotor in the SPM type rotary electric devices, but which has better performance than those previously employed.

It is a yet further object of the invention to provide a rotary electrical machine device that can reduce the distortion generated in the waveform of the electromotive force as much as possible while adopting inexpensive processes and assembling methods.

### SUMMARY OF INVENTION

This invention is adapted to be embodied in a rotary electrical machine comprised of a pair of relatively rotatable components comprising an armature having a core from which a plurality of circumferentially spaced pole teeth extend in a radial direction. Coil windings are formed around the pole teeth. The other of the components comprises a permanent component having a plurality of circumferentially spaced permanent magnets mounted on the periphery thereof in confronting and closely spaced relation to the tip ends of the pole teeth to define a generally cylindrical gap therebetween. In accordance with the invention, at least one of the pole teeth and the permanent magnets having planar surfaces facing the gap.

### BRIEF DESCRIPTION OF DRAWINGS

FIG. 1 is a side elevational view of a prior art type of SPM machine.

FIG. 2 is an enlarged view of the area encompassed by the circle 2 in FIG. 1.

FIG. 3 is waveform chart showing the waveform of counter electromotive force as the efficiency of the conventional SPM type rotary electric device as shown in FIGS. 1 and 2.

FIG. 4 is a graph showing analysis results of harmonic components included in the waveform illustrated in FIG. 3.

FIG. 5 is a graph showing the enlarged harmonic components shown in FIG. 4.

FIG. 6 is a side elevational view in part similar to FIG. 1, but shows a first embodiment of the invention.

FIG. 7 a graph showing the low harmonic distortion efficiency of the rotary electric device shown in FIG. 6.

FIG. 8 a tabular representation showing the low harmonic distortion efficiency of the rotary electric device shown in FIG. 6.

FIG. 9 is a side elevational view, in part similar to FIG. 6, but shows another embodiment of the invention.

FIG. 10 is a waveform chart of the electromotive force of the rotary electric device according to the embodiment shown in FIG. 9.

FIG. 11 a graph showing the low harmonic distortion efficiency of the rotary electric device shown in FIG. 9.

FIG. 12 a tabular representation showing the low harmonic distortion efficiency of the rotary electric device shown in FIG. 9.

FIG. 13 is a cross sectional view showing the finished body structure of a rotary electric device according to yet another embodiment of the present invention.

FIG. 14 is a view looking in the direction of the arrows 14-14 in FIG. 13.

### DETAILED DESCRIPTION

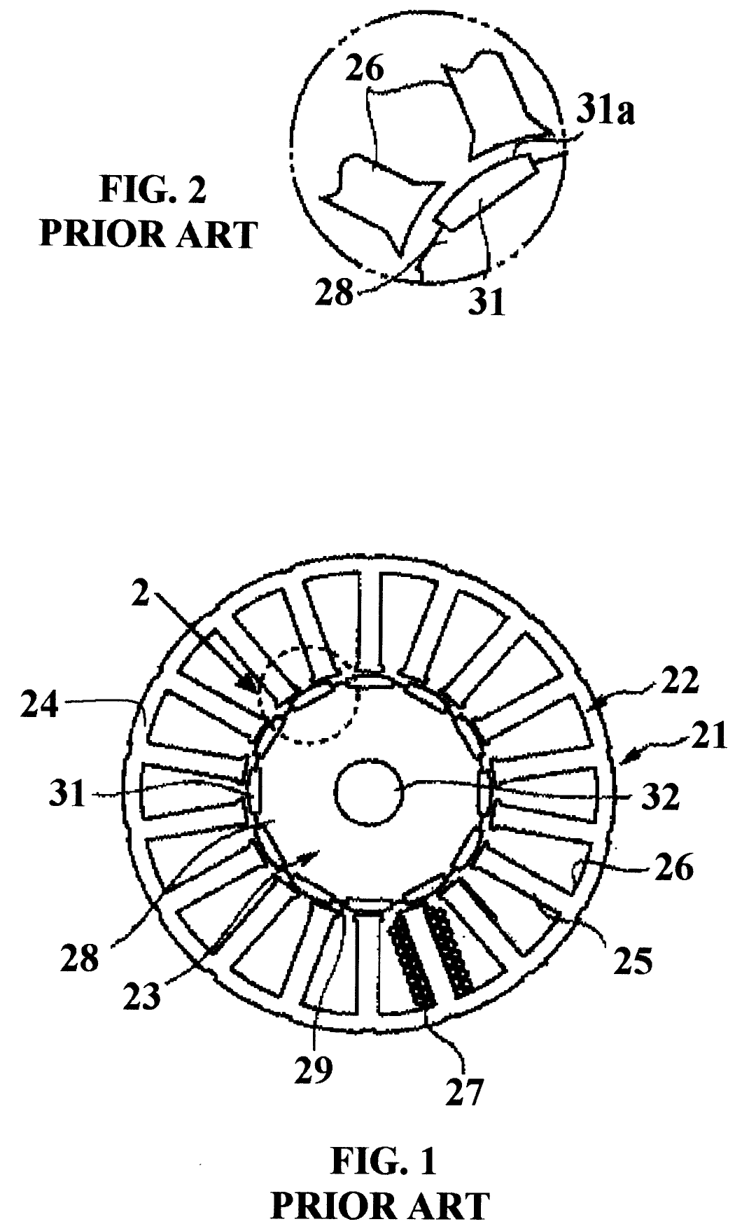

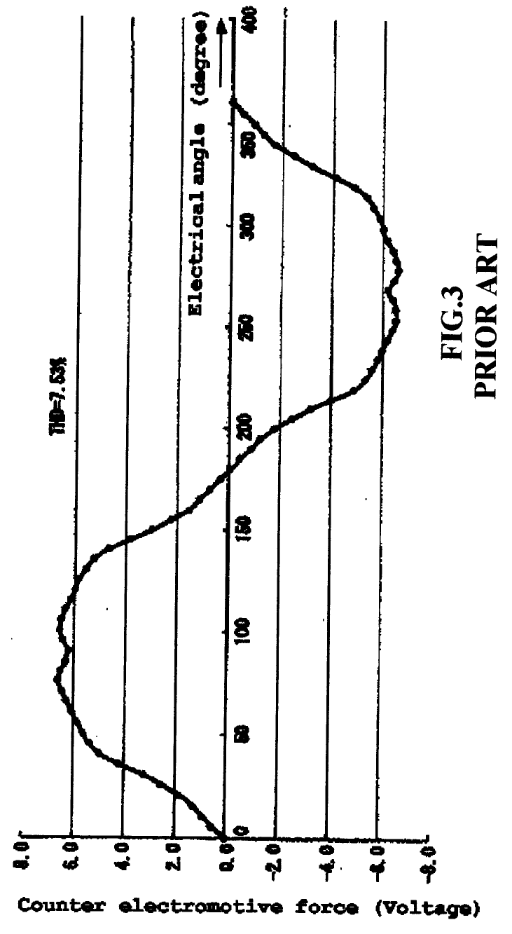

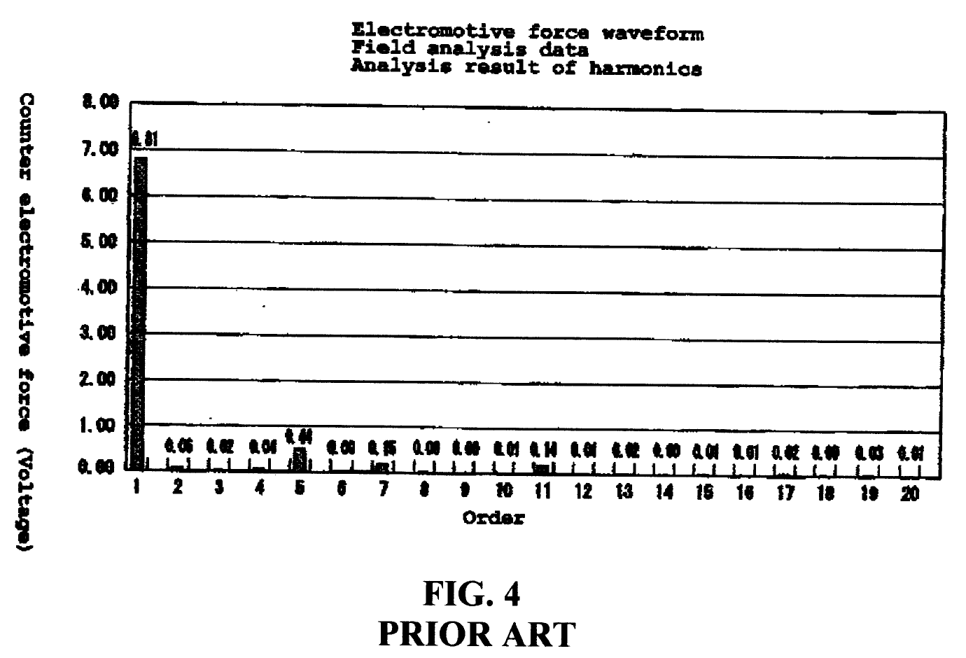

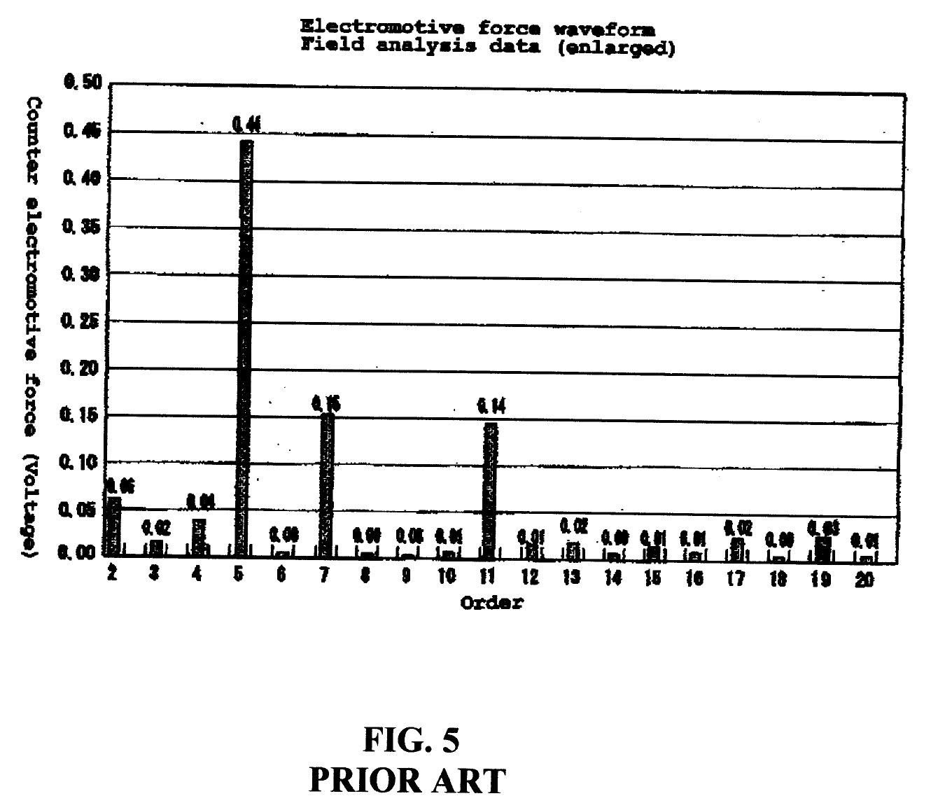

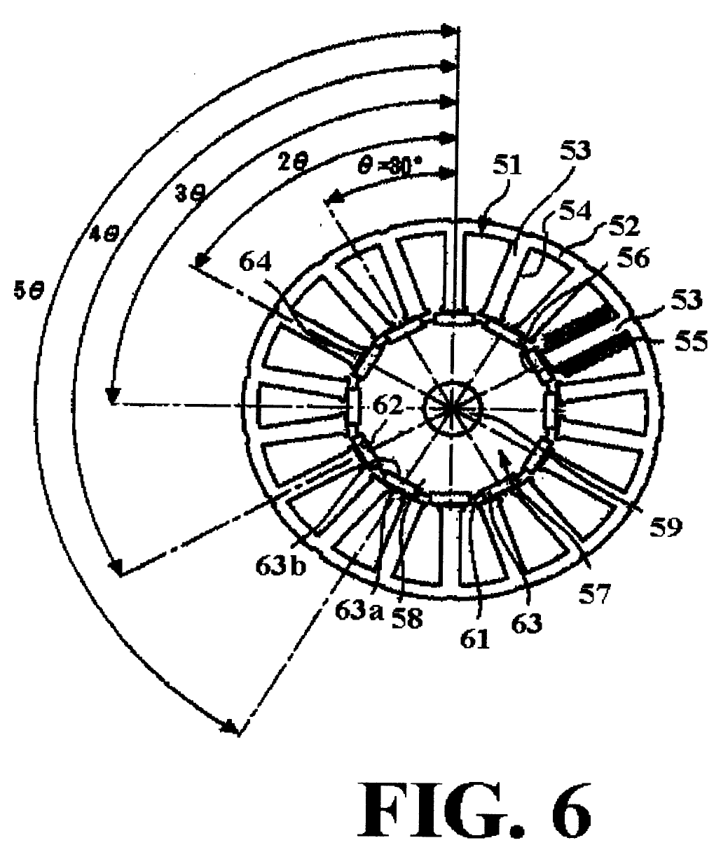

Referring now in detail to the drawings and first to the embodiment of FIGS. 6-8 and initially to FIG. 6, shows both yokes (cores) of the stator and the rotor removed from the rotary electric device according to an embodiment of the present invention. A stator, indicated generally at 51 of the rotary electric device has substantially the same structure as the conventional stator 21 shown in FIG. 1. That is it has a core 51 of a hollow cylindrical shape formed by laminating plural planar plates made of magnetic steel or other materials. Pole teeth (teeth) 53 extend radially inward from the core 52. Slots 54 are formed between the adjacent pole teeth 53.

Coils 55 is wound around each pole tooth 53 and extend through the slots 54 on both sides of the teeth 53. The radial inner end face of each of the pole teeth 53 is formed with a respective pole face 56.

A cooperating rotor, indicated generally at 57, is formed as a cylindrical member with a laminated core 58 and has insertion holes to receive a shaft 59 at their centers. The core 58 is made of magnetic steel or other like materials. The core 57 has a generally cylindrical outer surface 61 that is formed with a plurality of circumferentially spaced narrow grooves of generally rectangular configuration forming flat surfaces 62. Permanent magnets 63 are accommodated or seated in each of the grooves or flat surfaces 62 in manners to be described.

The permanent magnets 63 in this example are formed as a planar member of a rectangular shape having the desired thickness. The wide outwardly facing side surface forms an external pole face 63a. An internal pole face 63b is firmly bonded by, for example, an adhesive, and secured to the outer peripheral surface 61 of the rotor 57. This is then fixed by a mold resin agent (not shown) as described later to prevent detachment from the outer peripheral surface 61 of the rotor 57. Thus the entire structure is a laminated body of the rotor core 58.

In the illustrated embodiment, twelve (12) permanent magnets 63 are spaced and fixed in the circumferential direction at regular intervals (θ, 2θ, 3θ, . . . , nθ) and disposed to form a magnetic field in each magnet as well as 12 magnetic poles in all.

Each of the permanent magnets 63 is processed and assembled for example in the following method. A number of planar pieces are cut and separated from a cube shaped permanent magnet metal block and corrected in terms of the dimension to form a planar member having two flat surfaces for forming the pole faces 63a and 63b. Then, the planar member is bonded to the outer peripheral surface 61 of the rotor 57 and magnetized within a strong magnetic field to form the planar permanent magnet piece 63.

It is also possible to magnetize the permanent magnet piece 63 after the step of forming the planar member and then positioned, secured, and firmly bonded to the outer peripheral surface 61 of the rotor 57. The permanent magnet piece 63 is disposed on the outer peripheral surface 61 of the rotor 57 by appropriate disposing method of permanent magnets.

The rotor 57 is therefore constructed as an SPM type rotor having plural permanent magnets 63 for forming magnetic fields on the outer peripheral surface 61 and positioned in the radial direction opposite to the pole teeth faces 56 of the stator 51 through an annular gap 64 that is made as small as possible.

Adopting the configuration having such planar permanent magnets 63 allows the annular gap 64 opposite to the stator 51 to be narrowed to the lowest limit within the characteristics of the SPM type rotor. This therefore, allows magnetic flux of the field formed by each piece of the permanent magnets 63 to act on the coils 55 of the stator 51 and keeps the efficiency of generating electromotive force or rotating torque as a rotary electric device at a high level.

Furthermore, as described above, adopting the permanent magnet piece 63 as the planar magnet piece facilitates the manufacturing of the magnets and their assembly to the rotor 57. This contributes to the reduction of the manufacturing cost and also results in the possibility of a substantial reduction in the ratio of harmonic power component to fundamental sinusoidal power.

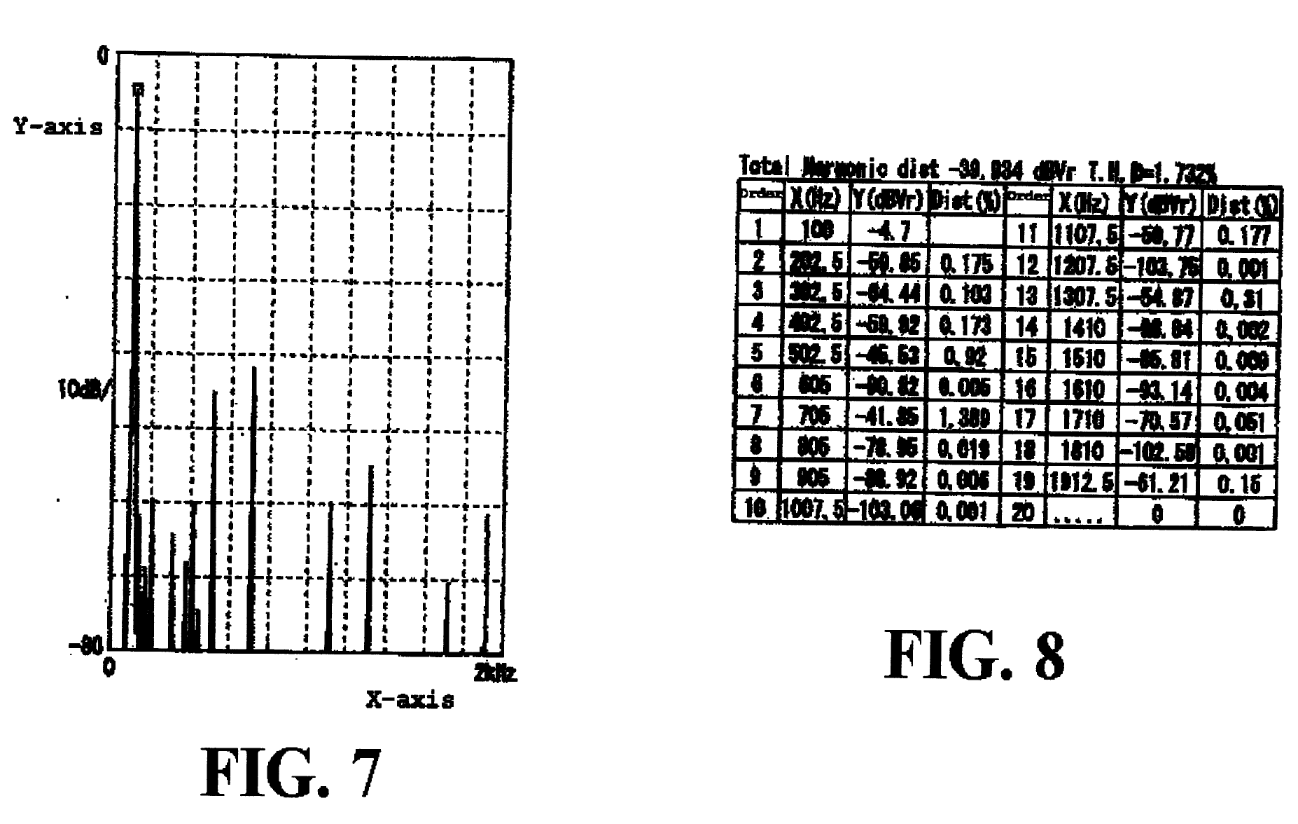

The total harmonic distortion (T.H.D) as a consequence of the measurement and analysis of counter electromotive force at the rotation as shown in FIGS. 7 and 8. FIG. 7 is a graph illustrating the ratio of respective harmonic components of 1st through 20th orders to the fundamental wave in spectral values, and harmonics in each order. Thease are shown within the frequency range of 100 Hz through approximately 2 kHz in the horizontal axis (X) and the ratio (dB) within the range of 0 through approximately 100 (dBVr) in the vertical axis (Y). FIG. 8 shows a tabular representation illustrating the result of FIG. 7. As the result, the total harmonic distortion (T.H.D) derived by addition and summation of the distortion factor (Dis: %) of the harmonics in each order is equal to 1.732% which is below 2%. Thus it is found that the T.H.D is significantly reduced as compared with the conventional distortion value of over 7%.

When the total harmonic distortion (T.H.D) is reduced in this way, remarkable effects can be achieved and the torque pulsation can be substantially reduced and concerns about the induction of malfunction in peripheral devices can be eliminated. Also the reliability of the rotary electric device is improved.

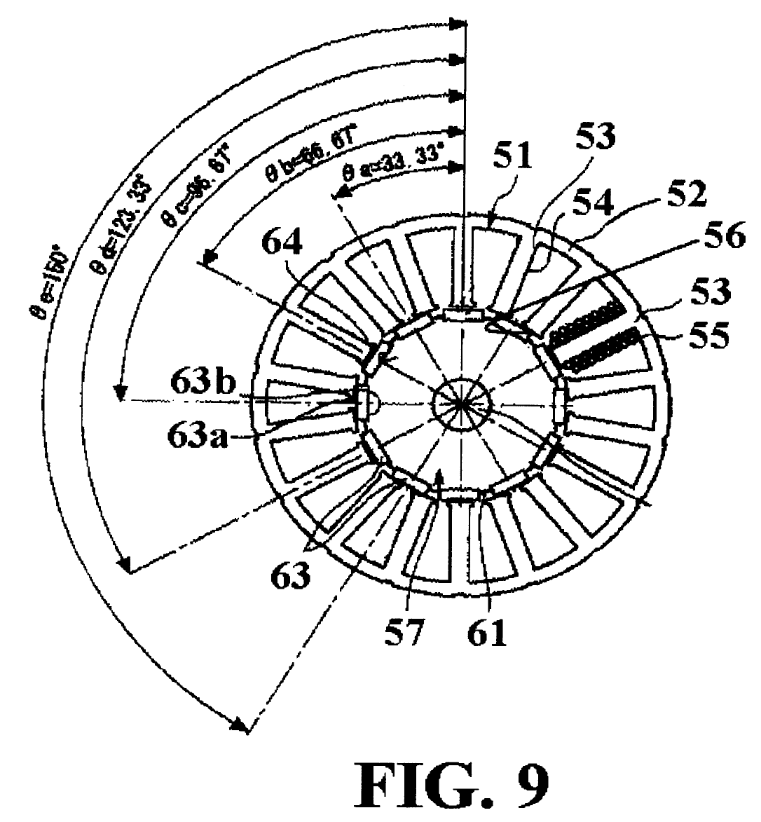

FIG. 9 shows an SPM type rotary electric device according to another embodiment of the present invention. The rotary electric device has substantially the same configuration and structure as the rotary electric device according to the embodiment shown in FIG. 6 and for that reason where the components thereof have substantially the same construction as that embodiment, they are identified by the same reference numerals and will not be described again in detail except where necessary for those skilled in the art to understand and practice this embodiment.

The embodiment of FIG. 9 differs from that of FIG. 6 in that the planar permanent magnets 63 fixed on the cylindrical outer peripheral surface 61 of the rotor 57 are disposed in the circumferential direction of the rotor 57 at irregular intervals (θa, θb, θc, θd, θe, . . . ) rather than equal increments. Therefore, advantages in the processing of the planar permanent magnets 63 can be obtained exactly the same way as the aforementioned embodiment.

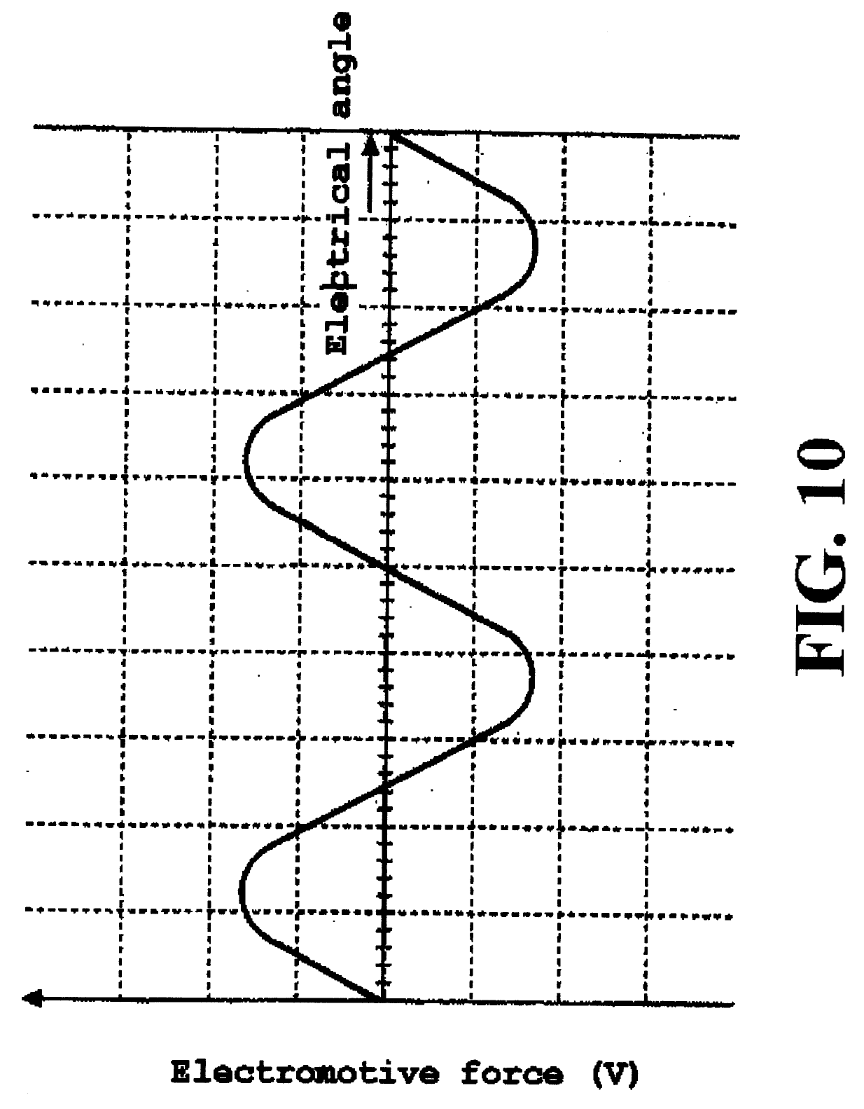

On the other hand, by adopting the configuration such that the planar permanent magnets 63 for forming a field are disposed in the circumferential direction of the cylindrical outer peripheral surface 61 of the rotor 57 at irregular intervals, a significant decrease of cogging can accomplished particularly when the rotary electric device is used as a motor. Therefore, when measurement is made for the waveform of the electromotive force of the SPM type rotary electric device according to this embodiment, it is confirmed to exhibit the sinusoidal waveform with almost no distortion as shown in FIG. 10.

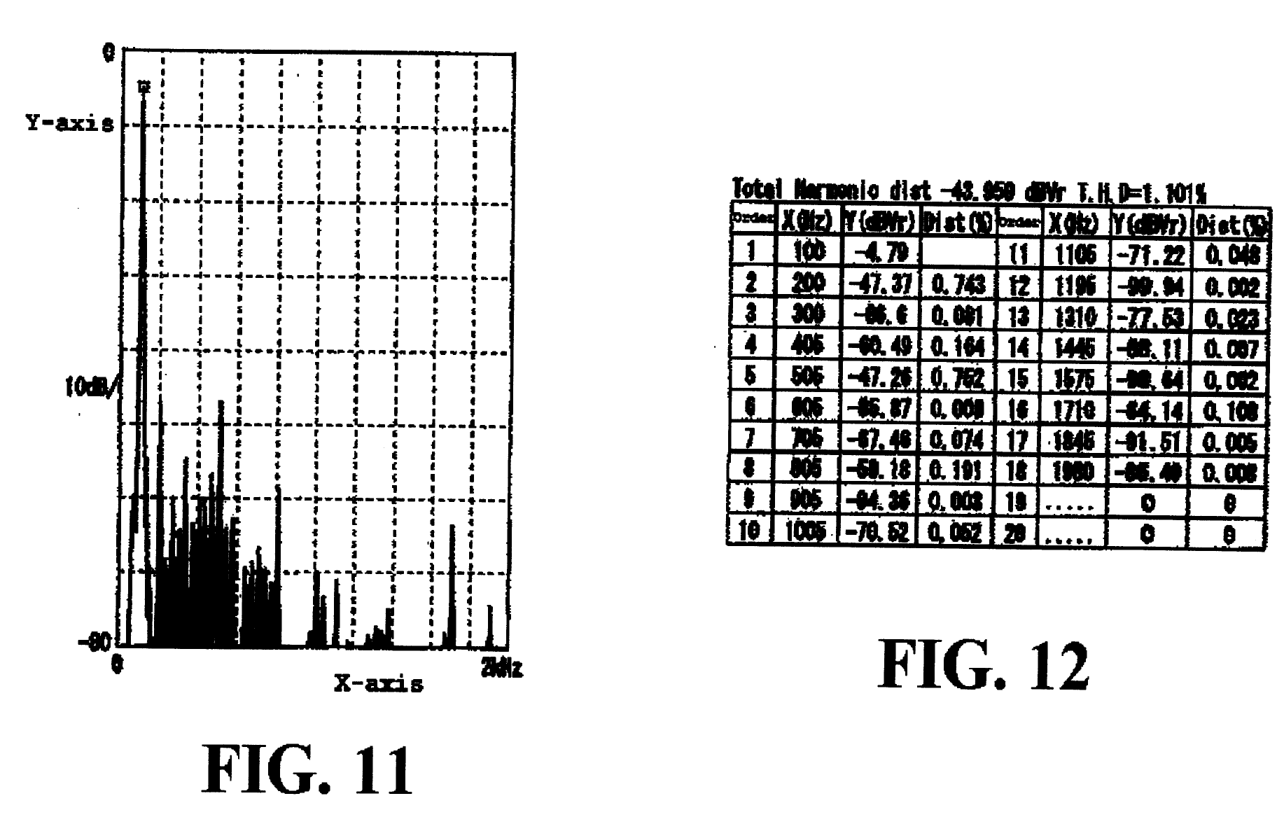

Furthermore, when an analysis is conducted on the harmonic components of the sinusoidal waveform in the electromotive force, the results shown in FIGS. 10 and 11 are obtained. In other words, FIGS. 10 and 11 show the components of electromotive force in each order of 1st- through 20th-order harmonic component in spectral and tabular representations in the same manner as the graph and tabular representation of the spectral value shown in FIGS. 7 and 8 of the previous embodiment.

The results in FIGS. 10 and 11 show that the total harmonic distortion is equal to 43.959 dBVr, even having distortion components in each order, and that the distortion (T.H.D) is further reduced to only 1.101% thus even below that of the previous embodiment. Therefore, it is found from the result that the harmonic component in the electromotive force of the SPM type rotary electric device according to the present embodiment is very small.

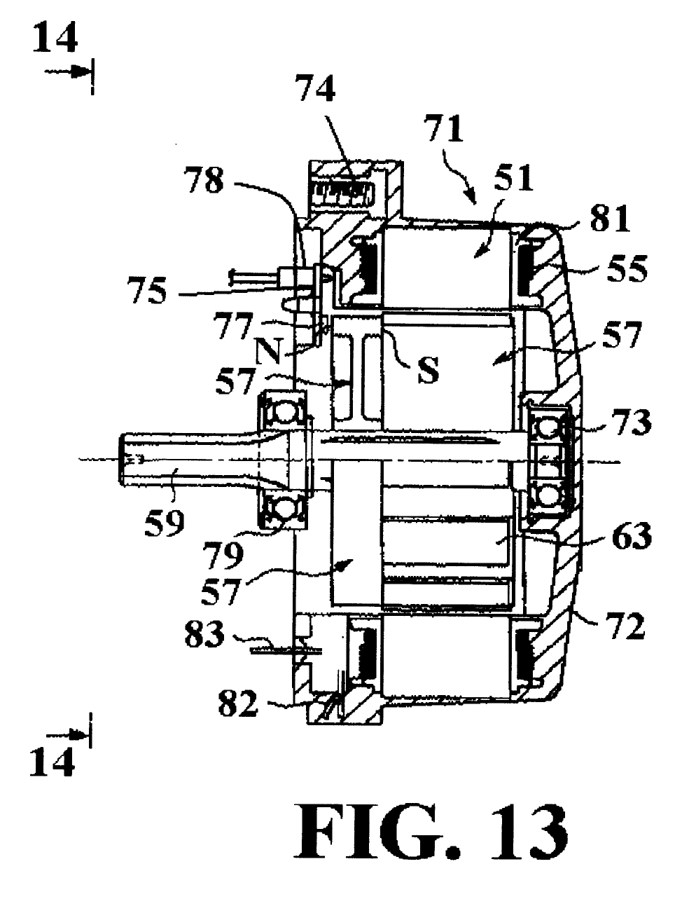

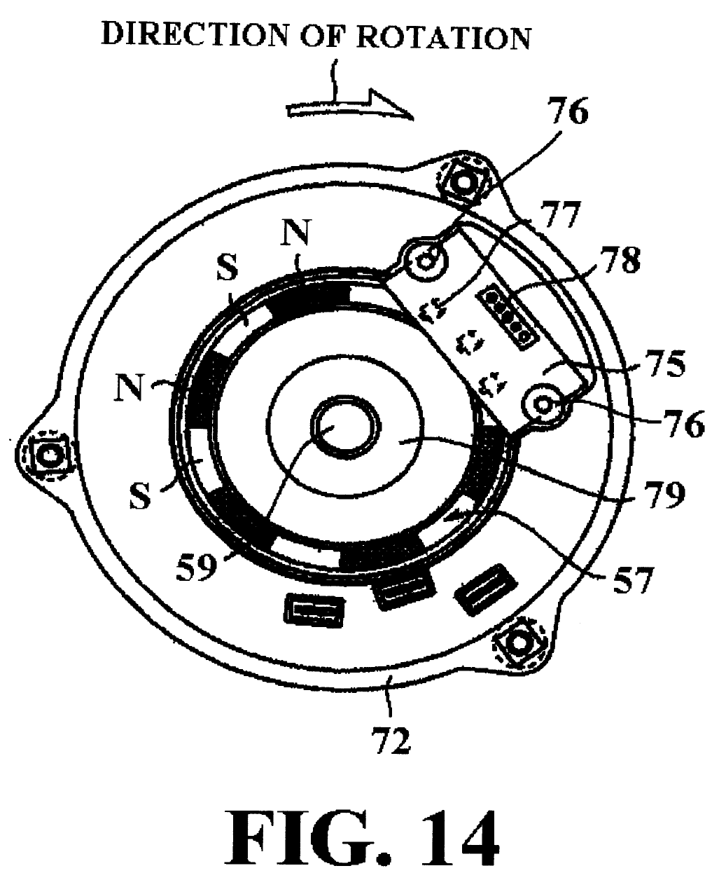

The previous drawings of the preferred embodiments have only shown the rotor and stator. Next will be described by reference to FIGS. 13 and 14 how these constructions can be embodied in a complete electrical machine which may comprise either a motor or a generator. In these views where components have the same construction as already described they are described again only in so far as is necessary to permit those skilled in the art to practice the invention.

The machine (motor or generator) is indicated generally by the reference numeral 71 is formed as a three-phase twelve-pole device integrated with the stator 51 and the rotor 57 and formed as a compact, integrated rotary electric device by way of molding each of the stator 51 and the rotor 57 with thermoplastic mold resin such as unsaturated polyester. The mold resin is injected into a molding die after the stator 51 is positioned in a respective molding die and hardened to form the housing body 72 of the machine 71. At this time a bearing 73 for one end of the rotor shaft 59 is positioned in the mold body.

After the housing body 72 is formed one end (the left side in FIG. 13) is open and the rotor 57 and its shaft 59 is inserted into the bearing 73 with the other end of the rotor shaft 59 protruding through this opening. Threaded fastener receivers 74 are molded into the body 72 around this opening at the time of molding.

An encoder circuit board 75 is mounted to the end surface of the mold resin housing body 72 by using by well-known push nuts 76. The circuit board 75 is provided with Hall effect devices (Hall IC) 77 and lead wire terminals 78. These Hall effect devices 77 cooperate with sensor magnets, the polarity of which is noted in FIGS. 13 and 14, mounted on a side surface of the rotor 57 to detect the rotational speed or rotation angle of the rotor 57. The sensor magnets are designed so that an annular magnetic material is magnetized such that the north and south poles are provided in the axial direction and alternately arranged in the circumferential direction. The magnetic field of the sensor magnets and the Hall effect devices 77 electromagnetically interact to constitute a rotary detector for detecting the rotational speed or rotation angle of the rotor 57.

A cover plate (not shown) carrying an external bearing 79 is then attached using fasteners and the receivers 74 to enclose the machine 71 with the one shaft end exposed for driving or driven relation.

The coils 55 of the stator 51 are constructed such that the coil end is held with an insulator bobbin 81 made from an appropriate insulating material and the coil end of each phase is connected with a coil terminal 82 disposed in the end surface of the stator 51 to input from or output to the coil 55 of each phase through input or output terminal 83.

Such rotary electric device 71 can be used as a motor when input current is supplied to the input terminal 39c or as a generator when the rotor shaft 33 is mechanically driven from the outside and electromotive force is taken from the output terminal 39c. Therefore, building in various external devices allows application to a power driving source or generator.

Thus from the foregoing description it should be readily apparent that it is possible to build a very compact and efficient rotary electrical machine at a low cost. Of course those skilled in the art will readily understand that the foregoing description is of preferred embodiments and various changes and modifications may be made without deviating from the spirit and scope of the invention, as defined by the appended claims.

1. A rotary electrical machine comprised of a pair of relatively rotatable components comprising an armature having a core from which a plurality of circumferentially spaced pole teeth extend in a radial direction, coil windings formed around said pole teeth and a permanent magnet component having a plurality of circumferentially spaced permanent magnets in confronting and closely spaced relation to the tip ends of said pole teeth to define a generally cylindrical gap therebetween, at least one of said pole teeth and said permanent magnets having planar surfaces facing said gap.

2. A rotary electrical machine as set forth in claim 1, wherein the permanent magnets have planar surfaces facing the gap.

3. A rotary electrical machine as set forth in claim 1, wherein the pole teeth have planar surfaces facing the gap.

4. A rotary electrical machine as set forth in claim 3, wherein both the pole teeth and the permanent magnets have planar surfaces facing the gap.

5. A rotary electrical machine as set forth in claim 2, wherein the permanent magnets are spaced from each other at equal circumferential distances.

6. A rotary electrical machine as set forth in claim 5, wherein the pole teeth have planar surfaces facing the gap.

7. A rotary electrical machine as set forth in claim 6, wherein both the pole teeth and the permanent magnets have planar surfaces facing the gap.

8. A rotary electrical machine as set forth in claim 2, wherein the permanent magnets are spaced from each other at different circumferential distances.

9. A rotary electrical machine as set forth in claim 8, wherein the pole teeth have planar surfaces facing the gap.

10. A rotary electrical machine as set forth in claim 9, wherein both the pole teeth and the permanent magnets have planar surfaces facing the gap.
